(19) United States
(12) Patent Application Publication
(10) Pub. No.: US 2011/0271495 A1
(43) Pub. Date: Nov. 10, 2011

(54) Bendable Belt Loop

(76) Inventor: Geneva Grainger, Austin, TX (US)

(21) Appl. No.: 13/082,460

(22) Filed: Apr. 8, 2011

Related U.S. Application Data
(60) Provisional application No. 61/343,769, filed on May 4, 2010.

(51) Int. Cl. A44B 11/04; F16B 47/00

(52) U.S. Cl. 24/304; 24/265 AL

(57) ABSTRACT

A belt's overlapping belt end is held in place (e.g., prevented from sagging) by a bendable belt loop. The bendable belt loop includes an internal structure or element that provides rigidity to the bendable belt loop yet remains flexible enough for repeated removal and fitment. The bendable belt loop may include an extension to prevent lateral movement. Metal wires forming the internal structure may be covered with insulation or padding, and further covered by a membrane made of fabric, simulated leather, leather, or other material intended to match the belt. Decorative elements (e.g., gems) may be added to the removable belt loop.

This application claims priority to provisional application 61/343,769 filed May 4, 2010. This invention was not made with government support.

### BACKGROUND

The present disclosure relates to accessories for belts worn as clothing.

### RELATED ART DESCRIPTIONS

Belts may overlap when worn. If a belt is relatively long, a free end (i.e., belt end) may sag. A portion of the belt end may be cut off to prevent sagging, which would result in an unsightly edge.

### BRIEF DRAWING DESCRIPTIONS

FIG. 1 depicts cross-sections of a belt, a belt end (of the belt), and an embodied bendable belt loop for coupling the belt end to the belt in accordance with disclosed embodiments;

FIG. 2 depicts the elements of FIG. 1 with the bendable belt loop partially bent to fit to the belt and belt end;

FIG. 3 depicts the elements of FIG. 1 with the belt loop fully bent into position around the belt end and belt;

FIG. 4 illustrates a front view of the belt, belt end, and bendable belt loop of FIG. 1;

FIG. 5 illustrates a front view of the belt, belt end, and bendable belt loop of FIG. 3;

FIG. 6 depicts cross-sections of another belt, belt end, and bendable belt loop, with the bendable belt loop having an overlapping portion;

FIG. 7 depicts the cross-section of an embodied bendable belt loop adapted with an extended element to prevent lateral movement of the belt loop along a belt end;

FIG. 8 depicts a cross-sectional view of the bendable belt loop from FIG. 7 fitted to a belt and belt end, with the extended element inserted into a pre-existing hole in the belt end;

FIGS. 9A-9B depict two cut-away views showing internal and external components of an embodied bendable belt loop; and

FIG. 10 represents a method of holding together a belt and its overlapping belt end.

### SUMMARY OF DISCLOSED EMBODIMENTS

An exemplary embodiment is an apparatus (e.g., bendable belt loop) for coupling an overlapping belt end of a belt to the belt. The apparatus includes an internal structure with one or more elongated members (e.g., wires) made of a first material such as steel or other alloy. The first material permits repeated bending around the belt and the belt end without a substantial decrease in performance of the material. The internal structure, due to the first material's characteristics (e.g., rigidity), generally maintains its shape to continually couple the belt end to the belt while worn. The apparatus is relatively easily bent around the belt end and belt manually (i.e., by hand without the aid of tools) by a user and can be removed and reused. The internal structure is covered or enclosed by a flexible material such as fabric, leather, or simulated leather. In some embodiments, a layer of insulation or padding is used between the covering and the internal structure for aesthetic reasons, to provide support for the covering, or to prevent portions of the internal structure from penetrating the covering.

Another exemplary embodiment is a removable belt loop that includes an internal structure made of a material that permits the internal structure to be bent into a first shape around a belt and its overlapping belt end. The internal structure's material generally holds (e.g., holds perhaps with some flexing and slight correctable deformations) the first shape while the belt loop is worn. The material has tensile strength, elasticity, spring characteristics, and resilience to allow the internal structure to be removed and refitted repeatedly around the belt and belt end portion to permit wearing multiple times without substantial damage to the internal structure. The material also permits the internal structure to be bent into a second shape for removing the belt loop. In time, with repeated wearing, the internal structure may fatigue, but ideally the material is selected to permit the user to wear the removable belt loop repeatedly over an extended period (e.g., years).

An outer membrane covers the internal structure. The outer membrane is made of a flexible material such as cloth, silk, synthetic fabric, plastic, leather, simulated leather, and the like. The internal structure may include one or more wires, in some cases wrapped or sheathed in insulation or padding to prevent the wires from showing through the outer membrane. Preventing the shape or form of the wires or other components of the internal structure from transmitting through the membrane may be done for aesthetic reasons, to contribute to durability, and to contribute to comfort. The internal structure may be made of a material such as metal, metallic alloy, steel, copper, aluminum, or synthetic materials that permit repeatedly wearing and removing the belt loop. The outer membrane may be adapted (e.g., using an adhesive such as glue) to cover the internal structure. The outer membrane may also be adapted to cover the internal structure using stitching, magnets, buttons, snap fittings or other methods. In other embodiments, the outer membrane may be formed around, bonded to, or sprayed onto the internal structure to achieve the function and look desired.

The internal structure and outer membrane of the bendable belt loop are adapted to wrap around the belt end portion and the belt. If the bendable belt loop is relatively long compared to the width of the belt, there may be overlap by the bendable belt loop's first end and second end. For using the bendable belt loop with a belt that is relatively wide compared to the length of the bendable belt loop, there may be a gap between the bendable belt loop's two ends. Ideally the gap is hidden against the user's clothing and not within view when the belt and bendable belt loop are worn normally. Accordingly, when the bendable belt loop is worn, it covers simultaneously a front surface of the belt end, a top edge of the belt end, a top edge of the belt, a bottom edge of the belt end, a bottom edge of the belt, and a portion of an inside surface of the belt. Thus, the bendable belt loop is wrapped around the belt end and the belt, holds a first shape, is readily removable by deforming to a second shape, prevents the belt end from sagging, and is capable of repeatedly wearing.

Another embodiment is a method of holding together a belt and its overlapping belt end. The method includes betiding a removable belt loop around the belt and the belt end. The removable belt loop includes an internal structure made of a material that holds its shape while it is worn with the belt and belt end. The material is resilient for repeatedly removing and reinstalling the belt loop around the belt and the belt end without substantial damage (e.g., plastic deformation) to the material. The removable belt loop also includes an outer membrane made of a second material such as cloth, leather, simulated leather, synthetic materials, and the like. The outer membrane is adapted to cover the internal structure and may be attached to the internal structure or to itself in an overlapping fashion using adhesive or stitching, as examples. The internal structure may be made of metal wire or similar materials. The method includes bending the belt loop around the belt end and the belt so that the belt loop generally continuously contacts a front surface of the belt end, a top edge of the belt end, a top edge of the belt, a bottom edge of the belt end, a bottom edge of the belt, and a portion of an inside surface (i.e., that contacts the user's clothing) of the belt.

### DESCRIPTION OF EMBODIMENTS

Embodied systems include bendable belt loops covered with materials such as leather, synthetic leather, animal hide, plastic, silk, synthetic fabric, cotton fabric, denim, or the like. These materials ideally match a belt aesthetically, and indeed may be cut to form a strip that resembles a belt loop or belt keeper that has been cut off the belt and straightened. The internal structure of an embodied belt loop is somewhat rigid, and is flexible for installation and removal. Also, the internal structure may have a memory to return to an original shape (as installed) when slightly deformed. In an exemplary embodiment, to make the internal structure, inside the fabric strips there may be two small wires that provide rigidity to the belt loop and help to hold its shape while worn. The small wires can be placed on the outer sides of the strips. The fabric strips are substantially completely sealed around the small wires so the wires are concealed under the fabric. The fabric strips may be sealed around the wire strips using stitching or adhesive, as examples. In exemplary embodiments, the small metal wires are completely enclosed and are hidden from sight while worn. The final product resembles a belt loop that has been straightened (when removed from the belt end and belt), but which can be bent for wearing.

An exemplary bendable belt loop is flexible and removable from the belt. The belt loop is made of flexible material that allows repeated installation and removal from the belt. To install the belt loop, it is bent around the free end of the belt first and wrapped around the main part of the belt, so that the ends of the belt loop are behind the main part of the belt and out of sight. For narrower belts, the ends of the belt loop may overlap with the belt loop as fitted. When the belt loop is fitted over relatively wide belts, the ends of the belt loop may have a gap between them after it is fitted. To prevent the belt loop from moving laterally once fitted, an exemplary belt loop may include an extended or raised portion (e.g., a cylindrical extension made of metal or other material) that interacts with a hole in the free end of the belt loop. Belt ends often have holes, or a hole can be added.

The internal structure of an embodied bendable belt loop may be single or multi-strand wire. The wires maybe formed from alloys including, as examples, stainless steel and cobalt-nickel alloy wires. The size of the wire cross sectional area of the wires is selected to affect the rigidity, elasticity, spring characteristics, and other characteristics that contribute to desired functionality of embodied belt loops. In an embodied bendable belt loop, the internal structure may include a single wire having different cross sectional sizes or shapes, for example to provide rigidity for vertical sections but provide flexibility for the portions bent around the belt end and belt loop. To contribute to longer service life, wire sizes of the internal structure may be minimized to a diameter that still provides desired rigidity.

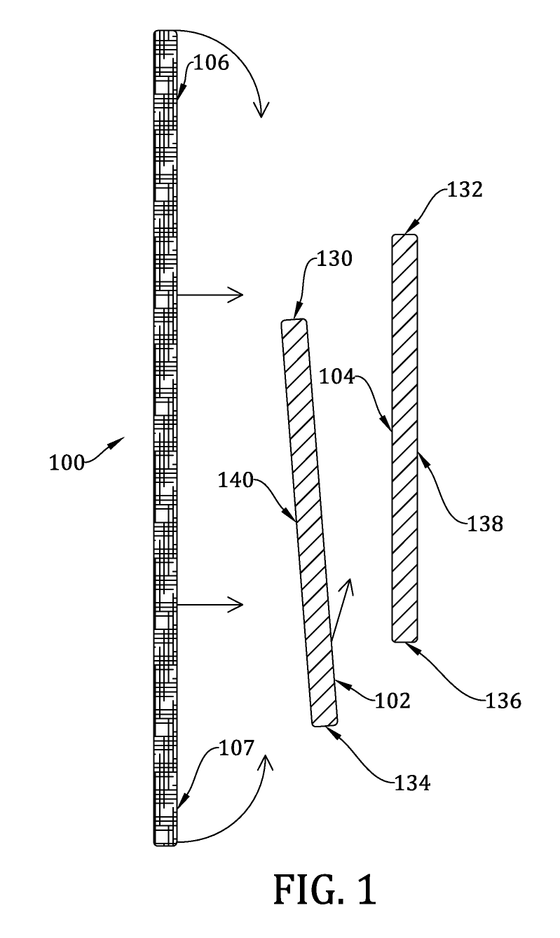

Referring now to the FIGS. 1-10, aspects related to embodied bendable belt loops and methods are depicted. In the various views, identical or similar objects may be identified with the same number. The figures are provided for informational purposes and some details are left out of the figures for clarity. Objects are not necessarily shown to scale or with realistic characteristic (e.g., the figures may not necessarily illustrate realistically the shape of a bent metal wire when depicting a belt loop bent around a belt end and belt).

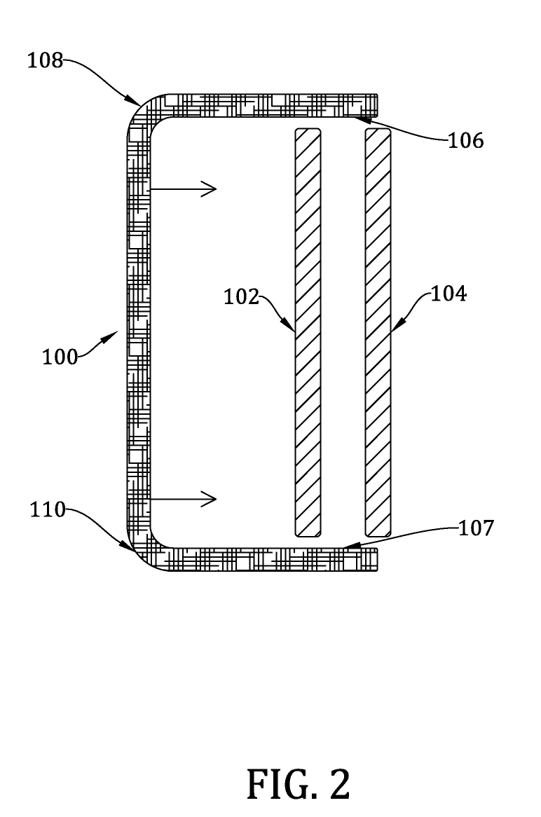

FIG. 1 illustrates bendable belt loop 100 having a first end 106 and a second end 107. Belt loop 100 is an embodied device adapted for wearing around belt end 102 and belt 104, in accordance with claimed subject matter, to prevent belt end 102 from sagging. FIG. 1 roughly depicts cross-sections of belt loop 100, belt end 102, and belt 104. The view of belt 104 represents the portion of a belt closest to a person's body when worn, and belt end 102 represents the overlap caused by belt 104 being longer than the girth of the person wearing the belt. If the person wears belt 104 and is facing the left of FIG. 1, then belt end 102 is coming out of the page. As shown, belt end 102 includes a top edge 130, a bottom edge 134, and a front surface 140. Belt loop 100, when initially bent for fitting (as shown in FIG. 2), has first end 106 and second end 107 bent substantially 90° toward top edge 130 and bottom edge 134, respectively. Belt 104 includes inside surface 138, top edge 132, and bottom edge 136. When fitted, belt loop 100 includes first end 106 and second end 107 wrapped around belt end 102 and belt 104 to make contact with internal surface 138 of belt 104 and front surface 140 of belt end 102.

FIG. 2 depicts the belt loop 100, belt end 102, and belt 104 of FIG. 1. As shown, belt loop 100's first end 106 and second end 107 are bent 90° toward belt end 102 and belt 104. Accordingly, belt loop 100 includes first bend 108 and second bend 110. As shown, belt end 102 is prevented from sagging, and is therefore aligned with belt 104, though a gap remains between the two.

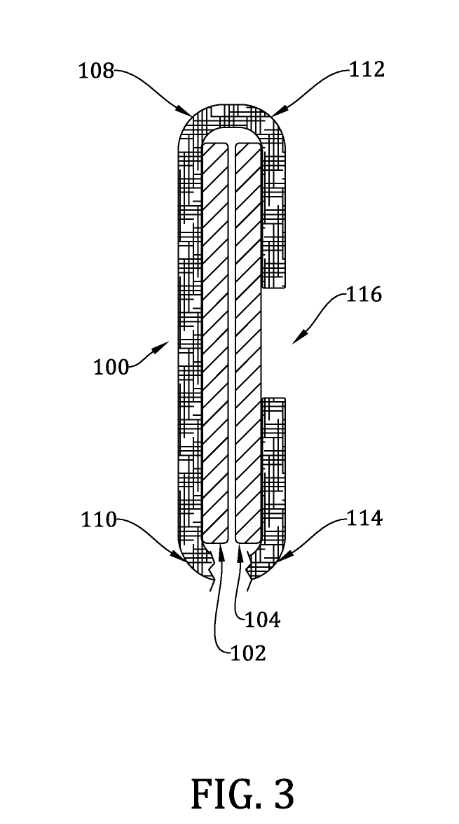

FIG. 3 shows the same items of FIG. 2 with the gap between belt end 102 and belt 104 closed, because belt loop 100 is fully fitted for wearing. As shown, FIG. 3 depicts belt loop 100, belt end 102, and belt 104 with belt loop 100 fully fitted (i.e., bent) around the belt end 102 and belt 104 for wearing. As shown, in addition to first bend 108 and second bend 110, belt loop 100 includes third bend 112 and fourth bend 114. After fitment of belt loop 100, gap 116 remains between belt loop 100's two ends. In some cases (e.g., fitment around wide belts) installation of belt loop 100 results in gap 116 being relatively large. Alternatively, in sonic cases there could be overlap (and effectively a negative value for gap 116). Belt loop 100 may be sized to minimize the overlap or gap. Accordingly, belt loop 100 may be sized to fit typical or expected widths and thicknesses of belt 104. Regardless, gap 116 should not be too large compared to the belt's width, and should accordingly allow for adequate friction between belt loop 100 and belt end 102.

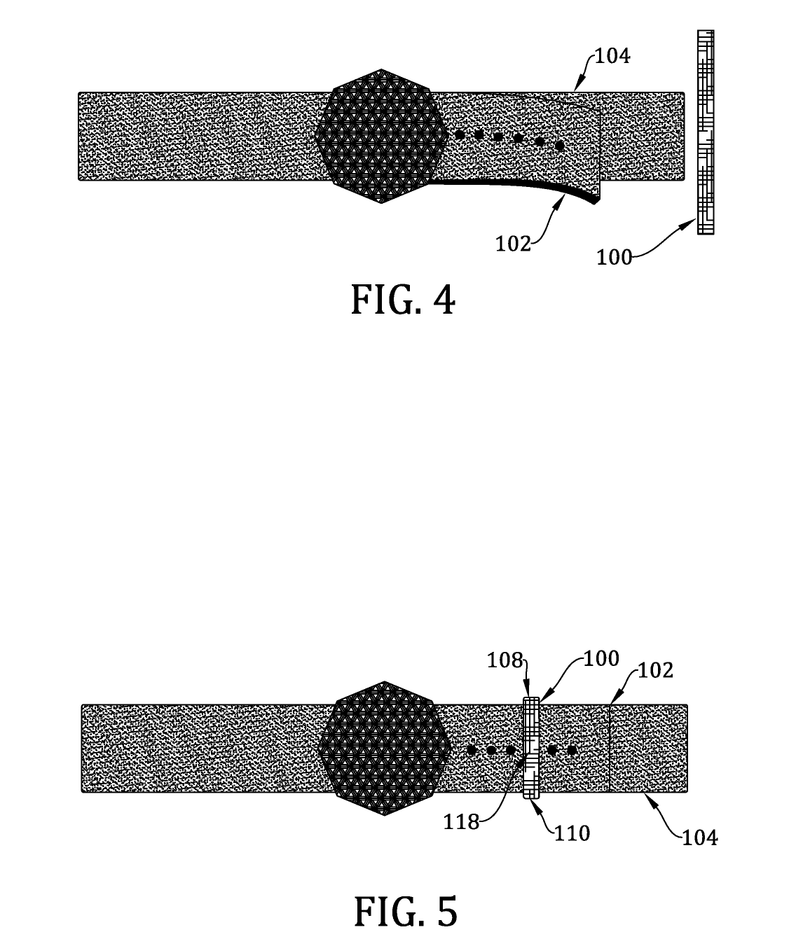

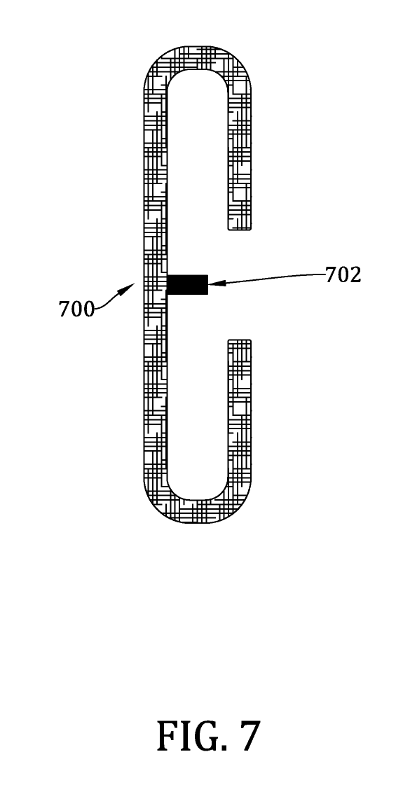

FIG. 4 depicts a frontal view of belt loop 100 (from FIG. 1) ready for fitting around belt 104 and belt end 102. As shown, belt end 102 sags compared to belt 104. FIG. 5 illustrates a front view of belt loop 100 (from FIG. 3) fitted around belt 104 for wearing. As shown, first bend 108 and second bend 110 contribute to belt loop 100 wrapping around belt 104. In some embodiments, belt loop 100 includes an extension (as shown in FIG. 7) for inserting into hole 118 (hidden behind belt loop 100 but in line and spaced with other holes shown) to prevent lateral movement (i.e., left and right) of belt loop 100 along belt end 102.

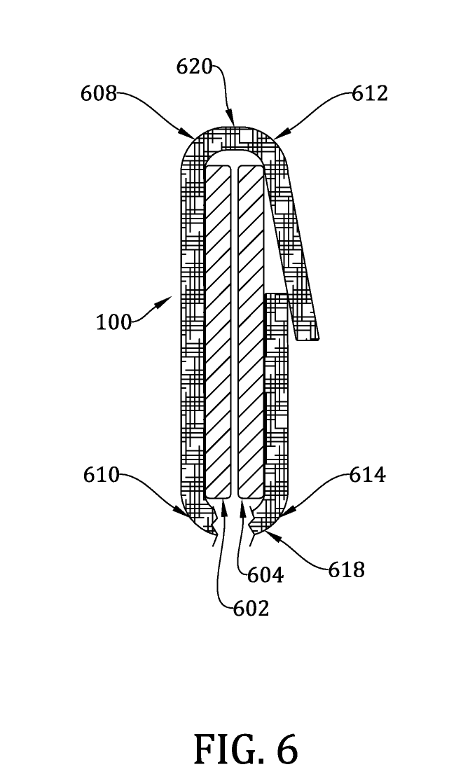

FIG. 6 depicts belt loop 600 that includes a first bend 608, a second bend 610, a third bend 612, and a fourth bend 614 that result in belt loop 100 (from FIG. 1) being worn around belt 604 and belt end 602. As shown, belt loop 100 is relatively long for the width and thickness of belt 604 and belt end 602, so there is an overlap of the two ends of belt loop 100. As shown, belt loop 100 is resilient and is able to be fitted to multiple belt widths during its useful life (e.g., years), and hold its shape while worn.

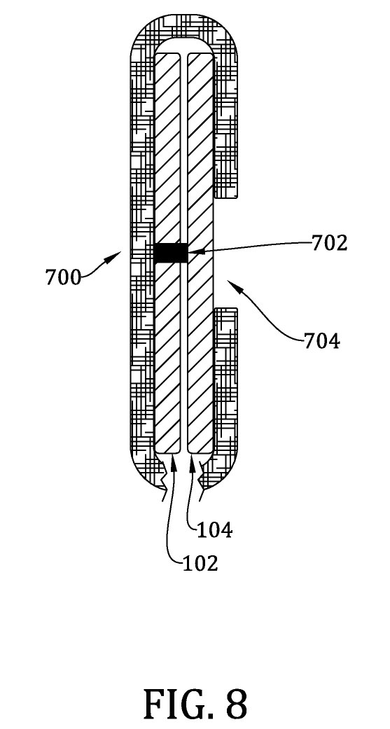

FIG. 7 depicts an alternate embodiment of a bendable belt loop (specifically belt loop 700) with an integrated extension 702. Extension 702 may be cylindrical for inserting into a belt hole (e.g., belt hole 118 in FIG. 5). As shown in FIG. 8, belt loop 700 is fitted around belt end 102 and belt 104, and extension 702 is inserted into belt end 102. As shown, the fitment of the loop 700 results in gap 704, which in embodiments may be relatively larger or smaller (to scale) than depicted in FIG. 8.

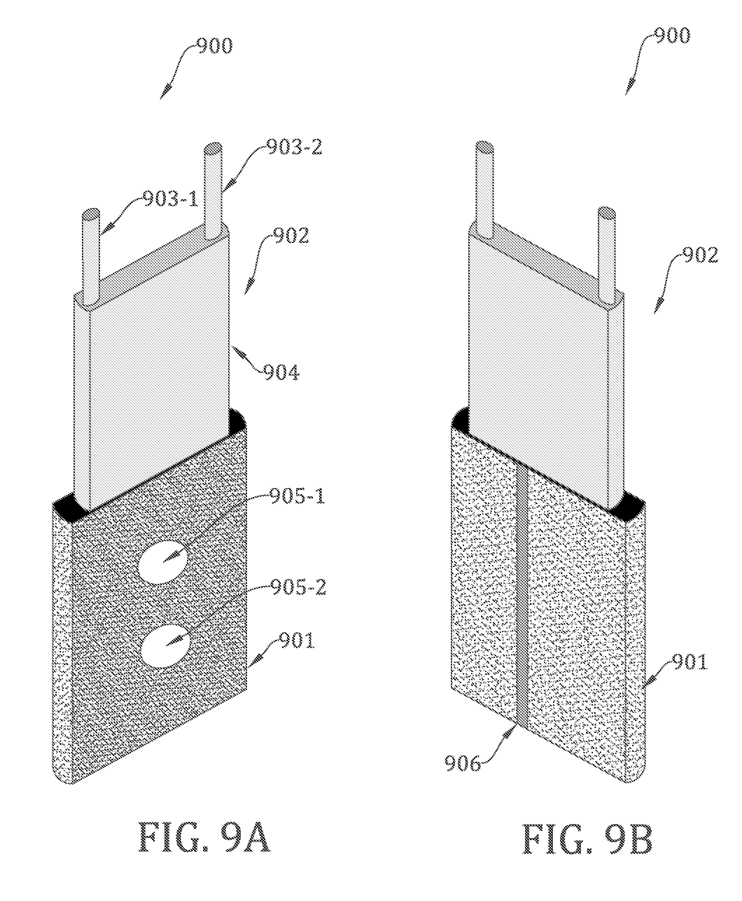

FIG. 9A illustrates a generally frontward facing view of bendable belt loop 900, which as shown includes internal structure 902. Internal structure 902 comprises metal wire 903-1 and metal wire 903-2. Membrane 901 surrounds internal structure 902. Belt loop 900 as shown also includes optional insulation 904. Insulation 904 may be a separate component that is wrapped around metal wire 903-1 and metal wire 903-2 or may be a part of membrane 901. Membrane 901 may be made of a synthetic material such as simulated leather and insulation 904 may be a backing for the synthetic material. Insulation 904 helps prevent the shape of metal wires 903-1 and 903-2 from transmitting through outside membrane 901. Insulation 904 may provide a thickness to bendable belt loop 901 that helps give it the same shape as a belt on which it is used. As shown, bendable belt loop 900 also includes ornaments 905-1 and 905-2, which may be simulated gemstones or other decorative elements (e.g., metal buttons, diamonds, gems, fabric elements), FIG. 9B illustrates the bendable belt loop 900 of FIG. 9A with seam 906. Seam 906 results from wrapping membrane 901 around internal structure 902 and sealing it. Membrane 901 may be sealed with adhesive, stitching, and the like.

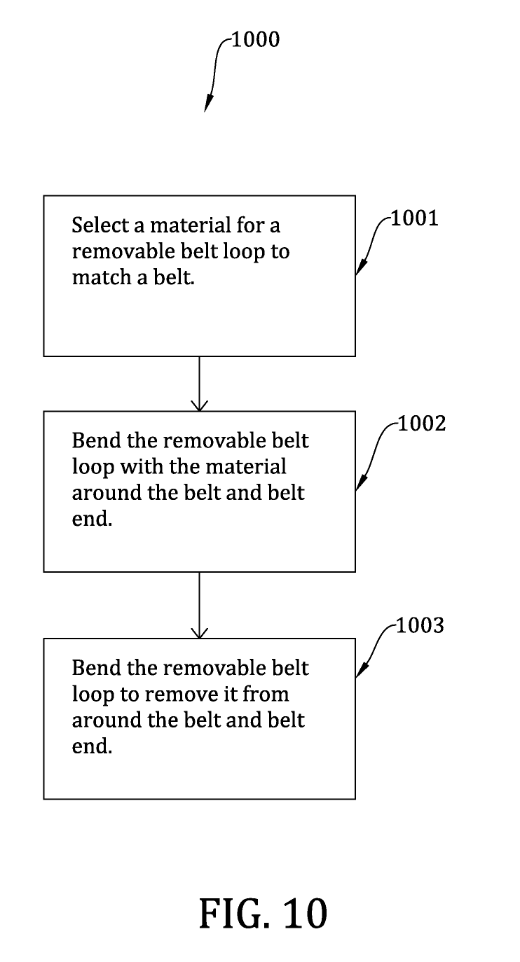

FIG. 10 depicts aspects of a claimed method 1000 for coupling a belt's overlapping end (e.g., belt end 102 in FIG. 1) to the belt (e.g., belt end 104 in FIG. 1) to prevent sagging. As shown, element 1001 relates to selecting a material for the removable belt loop to aesthetically match the belt. For example, if the belt is leather, a belt loop may be selected that is made of leather or faux leather. Element 1002 relates to bending the removable belt loop around the belt and belt end. Aspects related to bending a removable belt loop around a belt and belt end are depicted in FIG. 2, FIG. 3, and FIG. 6. As further shown in FIG. 10, the method includes element 1003 which is related to bending the removable belt loop to remove it from the belt and belt end. Accordingly, embodiments prevent sagging belt ends.

The subject matter of the claims includes numerous other embodiments than those expressly disclosed herein, and the claims are not meant to be limited to those embodiments detailed herein. Objects that embody the appended claims may be described herein as “exemplary belt loops,” “exemplary embodiments,” or similar terms. Such descriptions are meant to indicate examples of claim subject matter. The descriptions are nor meant to necessarily suggest, by use of the term “exemplary,” that one embodiment is better than another object.

What is claimed:

1. An apparatus for coupling a belt end to a belt, the apparatus comprising:
an internal structure comprising one or more elongated members made of a first material, wherein the first material permits repeated bending the internal structure around the belt end and the belt without a substantial decrease in performance of the material, wherein the first material permits the internal structure to maintain a first shape after bending the internal structure around belt end and belt, wherein the first material permits readily, manually bending the internal structure to a second shape for removal from the belt end and belt; and
a covering for enclosing the internal structure.

2. The belt loop of claim 1, wherein the internal structure is a metal wire.

3. The belt loop of claim 1, wherein the fabric strip is enclosed around the internal structure with stitching.

4. The belt loop of claim 1, wherein the fabric strip is enclosed around the internal structure with glue.

5. The belt loop of claim 1, further comprising:
padding between the fabric strip and the internal structure.

6. A method of holding together a belt and a belt end, the method comprising:
bending a removable belt loop around the belt and the belt end,
wherein the removable belt loop includes:
an internal structure made from a first material that holds a first shape while holding together the belt and the belt end, wherein the first material is resilient for repeatedly removing and reinstalling the belt loop around the belt and the belt end without substantial damage to the internal structure; and
an outer membrane made from a second material, wherein the outer membrane is adapted to cover the internal structure.

7. The method of claim 6, wherein the first material is metal wire.

8. The method of claim 7, wherein the second material is selected from: cloth, hide, leather, and simulated leather.

9. The method of claim 8, the method further comprising:
bending a portion of the removable belt loop to remove it from around the belt and the belt end.

10. The method of claim 9, wherein bending the removable belt loop around the belt end the belt and includes bending the removable belt loop such that it simultaneously contacts:
a front surface of the belt end;
a top edge of the belt;
a top edge of the belt end;
a bottom edge of the belt;
a bottom edge of the belt end; and
a portion of a back surface of the belt.

11. The method of claim 10, wherein the belt end the belt and are made from a third material, the method further comprising:
selecting the third material to match the second material.

12. A belt loop comprising:
an internal structure:
wherein the internal structure is made of a first material that permits the internal structure to be bent into a first shape for installing around a belt and a belt end portion for wearing,
wherein the first material causes the internal structure to hold the first shape while the belt loop is worn,
wherein the first material permits the internal structure to be bent into a second shape for removing the belt loop from the belt and belt end portion; and
an outer membrane adapted to cover the internal structure during wearing.

13. The belt loop of claim 12, wherein:
the first material causes the internal structure to be resilient for repeatedly removing and reinstalling the belt loop around the belt and the belt end portion to permit wearing around multiple times without substantial damage to the internal structure.

14. The belt loop of claim 12, wherein the outer membrane is made of a second material selected from: cloth, leather, and simulated leather.

15. The belt loop of claim 12, wherein the outer membrane is adapted to cover the internal structure using adhesive.

16. The belt loop of claim 12, wherein the outer membrane is adapted to cover the internal structure using stitching.

17. The belt loop of claim 12, wherein the first material is a selected from: metal, metallic alloy, steel, copper, or aluminum.

18. The belt loop of claim 17, wherein the internal structure includes one or more wires.
